(19) United States
(12) Patent Application Publication
(10) Pub. No.: US 2024/0247160 A1
(43) Pub. Date: Jul. 25, 2024

(54) WHITE INK FOR INKJET PRINTING

(71) Applicant: KYOCERA Document Solutions Inc., Osaka (JP)

(72) Inventor: Yukari KIDA, Osaka-shi (JP)

(73) Assignee: KYOCERA Document Solutions Inc., Osaka (JP)

(21) Appl. No.: 18/415,348

(22) Filed: Jan. 17, 2024

(30) Foreign Application Priority Data
Jan. 19, 2023 (JP) 2023-006588

(51) Int. Cl. C09D 11/322; C09D 11/033; C09D 11/037

(52) U.S. Cl. CPC C09D 11/322; C09D 11/033; C09D 11/037

(57) ABSTRACT

A white ink for inkjet printing contains titanium oxide particles and an aqueous medium. In particle size distribution measurement for the titanium oxide particles, the titanium oxide particles exhibit at least a first peak present in a particle diameter range between 40 nm and 55 nm and a second peak present in a particle diameter range between 165 nm and 340 nm. Where of the titanium oxide particles, titanium oxide particles with a particle diameter of at least 40 nm and no greater than 155 nm are taken as first titanium oxide particles and titanium oxide with a particle diameter of at least 165 nm and no greater than 340 nm are taken as second titanium oxide particles, ratios of major axis length to minor axis length of the first titanium oxide particles and the second titanium oxide particles each are at least 2 and no greater than 15.

### INCORPORATION BY REFERENCE

The present application claims priority under 35 U.S.C. § 119 to Japanese Patent Application No. 2023-006588, filed on Jan. 19, 2023. The contents of this application are incorporated herein by reference in their entirety.

### BACKGROUND

The present disclosure relates to a white ink for inkjet printing.

Typically, recording media such as flexible packaging (e.g., resin film) used in inkjet printing are transparent. When printing on such a transparent recording medium with a typical color ink for inkjet printing, opacity of a formed image may be insufficient and the printed portion may be difficult to see. As such, in order to ensure opacity of an image formed by inkjet printing on the flexible packaging, an underlying layer may be formed with a white ink for inkjet printing followed by printing on the underlying layer with the color ink for inkjet printing. Due to being used for the purpose such as above, the white ink for inkjet printing is required to be capable of forming images with high whiteness and opacity. When there are projections and recesses on the surface of the underlying layer, it is difficult to print on the underlying layer with a color ink for inkjet printing. As such, the white ink for inkjet printing is also required to be capable of forming images with high surface smoothness. In addition, the white ink for inkjet printing is further required to have excellent preservation stability.

Typically, the recording media such as flexible packaging used in inkjet printing are glossy. In inkjet printing on glossy recording media such as above, it is desirable to impart gloss to formed images in order to avoid creating a sense of discomfort in the printed area. As such, the white ink for inkjet printing is required to be capable of forming images with high glossiness. To meet the above requirements, a white ink for inkjet printing is proposed that contains titanium oxide particles and a pigment dispersion with a specific structure, for example.

### SUMMARY

A white ink for inkjet printing according to an aspect of the present disclosure contains titanium oxide particles and an aqueous medium. The titanium oxide particles exhibit at least a first peak and a second peak in particle size distribution measurement, the first peak being present in a particle diameter range of at least 40 nm and no greater than 155 nm, the second peak being present in a particle diameter range of at least 165 nm and no greater than 340 nm. Where of the titanium oxide particles, titanium oxide particles with a particle diameter of at least 40 nm and no greater than 155 nm are taken as first titanium oxide particles and titanium oxide with a particle diameter of at least 165 nm and no greater than 340 nm are taken as second titanium oxide particles, ratios of major axis length to minor axis length of the first titanium oxide particles and the second titanium oxide particles each are at least 2 and no greater than 15. The first titanium oxide particles have a percentage content of at least 12.0% by mass and no greater than 33.0% by mass in the titanium oxide particles. The second titanium oxide particles have a percentage content of at least 67.0% by mass and no greater than 88.0% by mass in the titanium oxide particles.

### DETAILED DESCRIPTION

The following describes embodiments of the present disclosure. Note that in the following, particle size distribution measurement for particles was carried out using a dynamic light scattering type particle size distribution analyzer (e.g., “NANOTRAC (registered Japanese trademark) WAVE II-EX150”, product of MicrotracBEL Corp.). The median diameter in the resultant particle size distribution was taken as a D₅₀ of the particles. In the present specification, the term particle diameter refers to an equivalent spherical diameter unless otherwise stated.

In the present specification, the term “(meth)acryl” may be used as a generic term for both acryl and methacryl. One type of each component described in the present specification may be used independently, or two or more types of the component may be used in combination.

### <White Ink for Inkjet Printing>

A white ink for inkjet printing (also referred to below as an ink) according to an embodiment of the present disclosure contains titanium oxide particles and an aqueous medium. The titanium oxide particles exhibit at least a first peak and a second peak in particle size distribution measurement. In the particle size distribution measurement, the first peak is present in a particle diameter range of at least 40 nm and no greater than 155 nm and the second peak is present in a particle diameter range of at least 165 nm and no greater than 340 nm. Where of the titanium oxide particles, titanium oxide particles with a particle diameter of at least 40 nm and no greater than 155 nm are taken as first titanium oxide particles and titanium oxide with a particle diameter of at least 165 nm and no greater than 340 nm are taken as second titanium oxide particles, ratios of the major axis length to the minor axis length of the first titanium oxide particles and the second titanium oxide particles each are at least 2 and no greater than 15. The first titanium oxide particles have a percentage content of at least 12.0% by mass and no greater than 33.0% by mass in the titanium oxide particles. The second titanium oxide particles have a percentage content of at least 67.0% by mass and no greater than 88.0% by mass in the titanium oxide particles. Preferably, the ink according to the present embodiment further contains either or both a pigment dispersion resin and binder resin particles.

The first titanium oxide particles form the first peak in the particle size distribution measurement for the titanium oxide particles. The second titanium oxide particles form a second peak in the particle size distribution measurement for the titanium oxide particles.

The ink according to the present embodiment is suitable for image formation on non-permeable recording media (especially, flexible packaging). The non-permeable recording media are inferior in ink permeability to permeable recording media. In the non-permeable recording media, the absorption amount of an aqueous medium is no greater than 1.0 g/m², for example. Examples of the non-permeable recording media include resin-made recording media, metal-made recording media, and glass-made recording media. Examples of the resin-made recording media include resin sheets and resin films. The resin contained in the resin-made recording media is preferably a thermoplastic resin. Specific examples of the resin include polyethylene, polypropylene, polyvinyl chloride, and polyethylene terephthalate (PET). Examples of the resin-made recording media include OPP films and PET films. In image formation on a resin-made recording medium with the ink according to the present embodiment, the surface (printing surface) of the recording medium may be subjected to corona discharge treatment.

The ink according to the present embodiment is preferably used in front printing. The front printing herein means printing on a surface on the front side (the side that is visible to a viewer) of a transparent recording medium when printing on the transparent recording medium. When the viewer views a recording medium on which front printing has been done, the positional relationship “the viewer, an image, and the recording medium” is established and the image is directly viewed by the viewer. Therefore, images formed by front printing tend to require particularly high glossiness.

Note that printing on a surface on the back side (the side opposite to the side that is visible to a viewer) of a transparent recording medium refers to reverse printing in printing on the transparent recording medium. When the viewer views a recording medium on which reverse printing has been done, the positional relationship “the viewer, the recording medium, and an image” is established and the image is viewed by the viewer through the recording medium. Therefore, images formed by reverse printing tend not to require such high glossiness.

As a result of having the above features, the ink according to the present embodiment has excellent preservation stability and can form images with high whiteness, opacity, glossiness, and surface smoothness. Note that images with high whiteness in the present specification means images with high lightness and less redness. The reasons why the ink according to the present embodiment can exert the above advantages can be inferred as follows.

The characteristics of the titanium oxide particles are described first. A closer diameter of the titanium oxide particles to the half wavelength of incident light tends to impart higher lightness and opacity to images formed with the ink. For example, an image formed with titanium oxide particles with a particle diameter of 200 nm exhibits particularly high lightness and opacity to incident light with a wavelength of 400 nm. Therefore, images containing titanium oxide particles with a particle diameter close to the half wavelength of visible light (e.g., titanium oxide particles with a particle diameter of at least 165 nm and no greater than 340 nm) have high lightness and opacity. By contrast, titanium oxide particles with a certain diameter or more (e.g., titanium oxide particles with a particle diameter of at least 165 nm) are characteristically reddish. However, images formed with titanium oxide particles with a relatively small particle diameter (e.g., titanium oxide particles with a particle diameter of at least 40 nm and no greater than 155 nm) are characteristically less reddish although lightness and opacity imparted to formed images are somewhat insufficient.

The ink according to the present embodiment contains as a white pigment the first titanium oxide particles with a particle diameter of at least 40 nm and no greater than 155 nm and the second titanium oxide particles with a particle diameter of at least 165 nm and no greater and 340 nm, each in a specific percentage content. With this feature, the second titanium oxide particles with a large particle diameter impart lightness and opacity to images formed with the ink according to the present embodiment and the first titanium oxide particles with a small particle diameter reduces redness of the formed images. As a result, the ink according to the present embodiment can form images with high whiteness and opacity. Furthermore, titanium oxide particles with an excessively large particle diameter (e.g., titanium oxide particles with a particle diameter of greater than 340 nm) tend to reduce preservation stability of an ink. The ink according to the present embodiment is excellent in preservation stability because the second peak formed by the second titanium oxide particles are present in a particle diameter range of at least 165 nm and no greater than 340 nm in the particle size distribution measurement for the titanium oxide particles and titanium oxide particles with an excessively large particle diameter are not included in large quantities.

Furthermore, the ratios of the major axis length to the minor axis length of the first titanium oxide particles and the second titanium oxide particles each are at least 2 and no greater than 15 in the ink according to the present embodiment. That is, the ink according to the present embodiment contains plate-shaped flat titanium oxide particles. The plate-shaped flat titanium oxide particles readily impart smoothness to the surfaces of images formed with the ink. The images with the smooth surfaces tend to exhibit gloss. As such, images formed with the ink according to the present embodiment have high surface smoothness and glossiness. Details of the ink according to the present embodiment are further described below.

### [Titanium Oxide Particles]

The ink according to the present embodiment contains titanium oxide particles as a white pigment. The titanium oxide particles exhibit at least a first peak and a second peak in particle size distribution measurement. In the particle size distribution measurement, the first peak is present in a particle diameter range of at least 40 nm and no greater than 155 nm and the second peak is present in a particle diameter range of at least 165 nm and no greater than 340 nm. Of the titanium oxide particles, titanium oxide particles with a particle diameter of at least 40 nm and no greater than 155 nm are taken as first titanium oxide particles and titanium oxide with a particle diameter of at least 165 nm and no greater than 340 nm are taken as second titanium oxide particles. The ratios of the major axis length to the minor axis length of the first titanium oxide particles and the second titanium oxide particles each are at least 2 and no greater than 15.

In the particle size distribution measurement for the titanium oxide particles, only a single first peak is preferably present in a particle diameter range of at least 40 nm and no greater than 155 nm although a plurality of first peaks may be present therein. In the particle size distribution measurement for the titanium oxide particles, only a single second peak is preferably present in a particle diameter range of at least 165 nm and no greater than 340 nm although a plurality of second peaks may be present therein. The titanium oxide particles preferably exhibit only the first peak and the second peak in the particle size distribution measurement. Note that the term peak refers to a point where the gradient is zero in an upwardly convex part when the particle size distribution is viewed as a graph.

The ink according to the present embodiment preferably contains no additional pigment other than the titanium oxide particles. Specifically, the percentage content of the additional pigment other than the titanium oxide particles is preferably no greater than 1.0% by mass in the ink according to the present embodiment, more preferably no greater than 0.1% by mass, and further preferably 0.0% by mass.

The percentage content of the titanium oxide particles is preferably at least 5.0% by mass and no greater than 25.0% by mass in the ink according to the present embodiment, and more preferably at least 10.0% by mass and no greater than 20.0% by mass. As a result of the percentage content of the titanium oxide particles in the ink according to the present embodiment being set to at least 5.0% by mass, further favorable whiteness and opacity can be imparted to images formed with the ink. As a result of the percentage content of the titanium oxide particles in the ink according to the present embodiment being set to no greater than 25.0% by mass, favorable ejection performance can be imparted to the ink.

### (First Titanium Oxide Particles)

The first titanium oxide particles reduce redness of images formed with the ink according to the present embodiment. The first peak is approximately equal to the volume median diameter of the first titanium oxide particles. The first peak is present in a particle diameter range of at least 40 nm and no greater than 155 nm, preferably in a particle diameter range of at least 80 nm and no greater than 155 nm, and further preferably in a particle diameter range of at least 120 nm and no greater than 155 nm. As a result of the first peak being present in a particle diameter range of at least 40 nm, the ink according to the present embodiment can impart high lightness and opacity to images formed with the ink. As a result of the first peak being present in a particle diameter range of no greater than 155 nm, redness of images formed with the ink according to the present embodiment can be reduced.

The first titanium oxide particles have a percentage content of at least 12.0% by mass and no greater than 33.0% by mass in the titanium oxide particles, and more preferably at least 17.0% by mass and no greater than 25.0% by mass. As a result of the percentage content of the first titanium oxide particles in the titanium oxide particles being set to at least 12.0% by mass, redness of images formed with the ink according to the present embodiment can be reduced. As a result of the percentage content of the first titanium oxide particles in the titanium oxide particles being set to no greater than 33.0% by mass, high lightness and opacity can be imparted to images formed with the ink according to the present embodiment.

The percentage content of the first titanium oxide particles is preferably at least 1.0% by mass and no greater than 8.0% by mass in the ink according to the present embodiment, and more preferably at least 2.0% by mass and no greater than 5.0% by mass. As a result of the percentage content of the first titanium oxide particles in the ink according to the present embodiment being set to at least 1.0% by mass, redness of images formed with the ink can be further effectively reduced. As a result of the percentage content of the first titanium oxide particles being set to no greater than 8.0% by mass in the ink according to the present embodiment, further favorable lightness and opacity can be imparted to images formed with the ink.

Note that the total percentage content of the first titanium oxide particles and the second titanium oxide particles is preferably at least 90.0% by mass in the titanium oxide particles, more preferably at least 99.0% by mass, and further preferably 100.0% by mass.

The percentage content of the first titanium oxide particles and the percentage content of the second titanium oxide particles in the titanium oxide particles can be calculated from their area ratios based on the particle size distribution measurement for the titanium oxide particles.

The ratio of the major axis length to the minor axis length of the first titanium oxide particles is at least 2 and no greater than 15, preferably at least 3 and no greater than 15, more preferably at least 4 and no greater than 10, and further preferably at least 4 and no greater than 8. As a result of the ratio of the major axis length to the minor axis length of the first titanium oxide particles being set to at least 2, high glossiness and surface smoothness can be imparted to images formed with the ink according to the present embodiment. As a result of the ratio of the major axis length to the minor axis length of the first titanium oxide particles being set to no greater than 15, excellent preservation stability can be imparted to the ink according to the present embodiment.

Note that the ratio of the major axis length to the minor axis length of the titanium oxide particles is a value as determined by the method described in Examples or a method in conformity therewith.

### (Second Titanium Oxide Particles)

The second titanium oxide particles impart sufficient lightness and opacity to images formed with the ink according to the present embodiment. The second peak is approximately equal to the volume median diameter of the second titanium oxide particles. The second peak is present in a particle diameter range of at 165 nm and no greater than 340 nm, and preferably in a particle diameter range of at least 200 nm and no greater than 280 nm. As a result of the second peak being present in a particle diameter range of at least 165 nm, the ink according to the present embodiment can impart high lightness and opacity to images formed with the ink according to the present embodiment. As a result of the second peak being present in a particle diameter range of no greater than 340 nm, the ink according to the present embodiment can exhibit excellent preservation stability and reduce redness of images formed with the ink.

The percentage content of the second titanium oxide particles is at least 67.0% by mass and no greater than 88.0% by mass in the titanium oxide particles, and preferably at least 75.0% by mass and no greater than 83.0% by mass. As a result of the percentage content of the second titanium oxide particles in the titanium oxide particles being set to at least 67.0% by mass, high lightness and opacity can be imparted to images formed with the ink according to the present embodiment. As a result of the percentage content of the second titanium oxide particles in the titanium oxide particles being set to no greater than 88.0% by mass, redness of images formed with the ink according to the present embodiment can be reduced.

The percentage content of the second titanium oxide particles is preferably at least 7.0% by mass and no greater than 16.0% by mass in the ink according to the present embodiment, and more preferably at least 10.0% by mass and no greater than 13.0% by mass. As a result of the percentage content of the second titanium oxide particles in the ink according to the present embodiment being set to at least 7.0% by mass, further favorable lightness and opacity can be imparted to images formed with the ink. As a result of the percentage content of the second titanium oxide particles in the ink according to the present embodiment being set to no greater than 16.0% by mass, redness of images formed with the ink can be further effectively reduced.

The ratio of the major axis length to the minor axis length of the second titanium oxide particles is at least 2 and no greater than 15, preferably at least 3 and no greater than 15, more preferably at least 5 and no greater than 15, and further preferably at least 6 and no greater than 9. As a result of the ratio of the major axis length to the minor axis length of the second titanium oxide particles being set to at least 2, high glossiness and surface smoothness can be imparted to images formed with the ink according to the present embodiment. As a result of the ratio of the major axis length to the minor axis length of the second titanium oxide particles being set to no greater than 15, excellent preservation stability can be imparted to the ink according to the present embodiment.

Preferably, the ratio of the major axis length to the minor axis length of the second titanium oxide particles is greater than the ratio of the major axis length to the minor axis length of the first titanium oxide particles. Specifically, the ratio of the major axis length to the minor axis length of the second titanium oxide particles is preferably at least 1.1 times and no greater than 2.0 times the ratio of the major axis length to the minor axis length of the first titanium oxide particles, and more preferably at least 1.3 times and no greater than 1.6 times.

### (Pigment Dispersion Resin)

The pigment dispersion resin attaches to the surfaces of the titanium oxide particles to optimize preservation stability of the titanium oxide particles in the aqueous medium. Note that a portion of the pigment dispersion resin may be free in the ink without attaching to the surfaces of the titanium oxide particles. Examples of the pigment dispersion resin include polyether resin, (meth)acrylic resin, styrene-(meth)acrylic resin, and styrene-maleic acid resin.

The pigment dispersion resin has a percentage content of preferably at least 1.0% by mass and no greater than 10.0% by mass in the ink according to the present embodiment, and more preferably at least 3.0% by mass and no greater than 6.0% by mass. As a result of the percentage content of the pigment dispersion resin being set to at least 1.0% by mass, dispersion stability of the titanium oxide particles in the aqueous medium can be further optimized. As a result of the percentage content of the pigment dispersion resin being set to no greater than 10.0% by mass, excellent ejection performance can be imparted to the ink according to the present embodiment.

The ink according to the present embodiment has a ratio of the mass of the pigment dispersion resin to the mass of the titanium oxide particles of preferably at least 0.10 and no greater than 0.50, and more preferably at least 0.25 and no greater than 0.35. As a result of the ratio of the mass of the pigment dispersion resin to the mass of the titanium oxide particles being set to at least 0.10 and no greater than 0.50, dispersion stability of the titanium oxide particles in the aqueous medium can be further optimized.

### [Aqueous Medium]

The aqueous medium contained in the ink according to the present embodiment is a medium containing water. The aqueous medium may function as a solvent or a dispersion medium. A specific example of the aqueous medium is an aqueous medium containing water and a water-soluble organic solvent.

### (Water)

The water has a percentage content of preferably at least 25.0% by mass and no greater than 80.0% by mass in the ink according to the present embodiment, and more preferably at least 30.0% by mass and no greater than 60.0% by mass.

### (Water-Soluble Organic Solvent)

Examples of the water-soluble organic solvent include glycol compounds, glycol ether compounds, lactam compounds, nitrogen-containing compounds, acetate compounds, thiodiglycol, glycerin, and dimethyl sulfoxide.

Examples of the glycol compounds include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol. A preferable glycol compound is propylene glycol.

Examples of the glycol ether compounds include diethylene glycol diethyl ether (diethyl diglycol), diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether. A preferable glycol ether compound is triethylene glycol monobutyl ether.

Examples of the lactam compounds include 2-pyrrolidone and N-methyl-2-pyrrolidone.

Examples of the nitrogen-containing compounds include 1,3-dimethylimidazolidinone, formamide, and dimethyl formamide.

Examples of the acetate compounds include diethylene glycol monoethyl ether acetate.

The water-soluble organic solvent is preferably a glycol compound or a glycol ether compound, and more preferably propylene glycol or triethylene glycol monobutyl ether.

The water-soluble organic solvent has a percentage content of preferably at least 20.0% by mass and no greater than 60.0% by mass in the ink according to the present embodiment, and more preferably at least 35.0% by mass and no greater than 45.0% by mass.

The percentage content of a glycol compound is preferably at least 15.0% by mass and no greater than 50.0% by mass in the ink according to the present embodiment, and more preferably at least 25.0% by mass and no greater than 35.0% by mass.

The percentage content of a glycol ether compound is preferably at least 3.0% by mass and no greater than 20.0% by mass in the ink of the present embodiment, and more preferably at least 7.0% by mass and no greater than 15.0% by mass.

Preferably, the ink according to the present embodiment contains as the aqueous medium only water, propylene glycol, and triethylene glycol monobutyl ether. The total percentage content of the water, propylene glycol, and triethylene glycol monobutyl ether is preferably at least 90% by mass in the aqueous medium, more preferably at least 99% by mass, and further preferably 100% by mass.

### (Binder Resin Particles)

The binder resin particles are present in a dispersed state in the aqueous medium. The binder resin particles function as a binder in images formed with the ink according to the present embodiment to optimize fixability of the titanium oxide particles to recording media.

Examples of the resin contained in the binder resin particles include urethane resin, (meth)acrylic resin, styrene-(meth)acrylic resin, styrene-maleic acid copolymers, vinylnaphthalene-(meth)acrylic acid copolymers, and vinylnaphthalene-maleic acid copolymers. Urethane resin is preferable as the resin contained in the binder resin particles. The percentage content of the urethane resin is preferably at least 80% by mass in the binder resin particles, and more preferably 100% by mass.

The binder resin particles have a volume median diameter of preferably at least 10 nm and no greater than 500 nm, and more preferably at least 10 nm and no greater than 100 nm.

The binder resin particles have a percentage content of preferably at least 0.5% by mass and no greater than 10.0% by mass in the ink according to the present embodiment, and more preferably at least 2.0% by mass and no greater than 5.0% by mass. As a result of the percentage content of the binder resin particles being set to at least 0.5% by mass, fixability of the titanium oxide particles to recording media can be further optimized. As a result of the percentage content of the bonder resin particles being set to no greater than 10.0% by mass, ejection performance of the ink according to the present embodiment can be optimized.

### (Surfactant)

Preferably, the ink according to the present embodiment further contains a surfactant. The surfactant optimizes compatibility and dispersion stability of each component contained in the ink according to the present embodiment. Furthermore, the surfactant imparts to the ink according to the present embodiment wettability to recording media. The surfactant in the ink according to the present embodiment is preferably a nonionic surfactant.

Examples of the nonionic surfactant in the ink according to the present embodiment include acetylene glycol surfactants (surfactants containing an acetylene glycol compound), silicone surfactants (surfactants containing a silicone compound), and fluorine surfactants (surfactants containing fluororesin or a fluorine-containing compound). Examples of the acetylene glycol surfactants include ethylene oxide adducts of acetylene glycol and propylene oxide adducts of acetylene glycol.

The surfactant has a percentage content of preferably at least 0.1% by mass and no greater than 3.0% by mass in the ink according to the present embodiment, and more preferably at least 0.5% by mass and no greater than 1.5% by mass.

### (Base Component)

Preferably, the ink according to the present embodiment further contains a base component. Examples of the base component include sodium hydroxide and potassium hydroxide. Preferably, the base component has a percentage content of at least 0.001% by mass and no greater than 0.010% by mass in the ink according to the present embodiment.

### [Optional Component]

The ink according to the present embodiment may further contain any known additives (specific examples include a solution stabilizer, an anti-drying agent, an antioxidant, a viscosity modifier, a pH adjuster, and an antifungal agent) according to necessity.

### [Ink Production Method]

The ink according to the present embodiment can be produced for example by mixing a first titanium oxide particle dispersion containing the first titanium oxide particles, a second titanium oxide particle dispersion containing the second titanium oxide particles, the aqueous medium, and any optional components (e.g., the surfactant, a dispersion containing the binder resin particle, and an aqueous solution containing the base component) added as necessary. In production of the ink according to the present embodiment, uniform mixing of each component may be followed by removal of foreign matter and coarse particles using a filter (e.g., a filter with a pore size of no greater than 5 μm).

For example, the first titanium oxide particle dispersion or the second titanium oxide particle dispersion can be prepared by wet dispersion of water, the pigment dispersion resin added as necessary, and the first titanium oxide particles or the second titanium oxide particles using a bead mill or the like. Note that the first peak and the second peak in the produced ink approximately equal to the volume median diameters of the first titanium oxide particles and the second titanium oxide particles in the respective dispersions used as raw materials.

### Examples

The following describes examples of the present disclosure. However, the present disclosure is not limited to the following examples.

In Examples, of two types of titanium oxide particles contained in an ink, one with a smaller particle diameter may be referred to as a “small-diameter titanium oxide particles” and the other one with a larger particle diameter may be referred to as a “large-diameter titanium oxide particles” for convenience.

### [Particle Size Distribution Measurement]

Particle size distribution measurement for titanium oxide particle dispersions was carried out using a particle size distribution analyzer (“NANOTRAC (registered Japanese trademark) WAVE II-EX150”, product of MicrotracBEL Corp.). The median diameters in the obtained particle size distributions were each taken as a D₅₀ of corresponding titanium oxide particles.

### [Ratio of Major Axis Length to Minor Axis Length]

The ratio of the major axis length to the minor axis length of titanium oxide particles was measured using a transmission electron microscope (TEM, “JEM-2000FX”, product of JEOL Ltd.). For image capturing, the accelerating voltage was set to 80 kV and the magnification was set to 30,000×. In the image capturing, the major axis lengths and the minor axis lengths of 10 particles randomly selected from each type of the first titanium oxide particles or the second titanium oxide particles in a field of view were measured. Next, an arithmetic mean (average major axis length) of the measured major axis lengths and an arithmetic mean (average minor axis length) of the measured minor axis lengths of the 10 particles were calculated. A value obtained by dividing the average major axis length by the average minor axis length was taken as a major axis length/minor axis length ratio of the first titanium oxide particles or the second titanium oxide particles present in the measured field of view. The above measurement was carried out in 10 fields of view. An arithmetic mean of the major axis length/minor axis length ratios of the first titanium oxide particles or the second titanium oxide particles measured in the fields of view was adopted as a measurement value of the major axis length/minor axis length ratio of the first titanium oxide particles or the second titanium oxide particles to be a measurement target.

Note that the “major axis length” was defined as the distance between two virtual parallel lines that could sandwich a particle of the measurement target and that were set so that the distance therebetween was the maximum. The “minor axis length” was defined as the width of a portion of the particle of the measurement target that intersected with a third virtual parallel line set to be equidistant from each of the two virtual parallel lines.

Note that in the determination of the major axis length/minor axis length ratio, it was confirmed whether or not titanium oxide particles in each field of view of the transmission electron microscope corresponded to the first titanium oxide particles or the second titanium oxide particles based on the equivalent circle diameter.

### [Preparation of Titanium Oxide Particle Dispersions (A1) to (A9)]

Titanium oxide particle dispersions (A1) to (A9) were prepared by the following methods. In the preparation of the titanium oxide particle dispersions (A1) to (A9), titanium oxide particles (a1) to (a9) shown below in Table 1 were used. In Table 1 below, “a/b” refers to a ratio (major axis length/minor axis length) of a major axis length (a) to a minor axis length (b). The same applies to Tables 2 to 4 below. The titanium oxide particle dispersions (A2), (A3), and (A5) to (A8) were first titanium oxide particle dispersions.

### (Titanium Oxide Particle Dispersion (A1))

A mixture was obtained by mixing 50.0 parts by mass of the titanium oxide particles (a1) (volume median diameter 30 nm, major axis length/minor axis length ratio=5), 14.5 parts by mass of a pigment dispersion resin (“SOLSPERSE (registered Japanese trademark) W100”, product of Lubrizol Japan Limited, main component: polyether-based resin), and 35.5 parts by mass of water. Dispersion treatment was carried out on the resultant mixture for 60 minutes using a bead mill (“RESEARCH LAB”, product of Shinmaru Enterprises Corporation). In the dispersion treatment, zirconia beads with a diameter of 1.0 mm were charged into a vessel of the bead mill to achieve a loading rate of 70% by volume. Also in the dispersion treatment, the treatment speed was set to 8 m/sec. In the manner described above, a titanium oxide particle dispersion (A1) (volume median diameter of titanium oxide particles: 30 nm, titanium oxide particle concentration: 50% by mass) was produced.

### (Titanium Oxide Particle Dispersions (A2) to (A9))

Titanium oxide particle dispersions (A2) to (A9) (titanium oxide particle concentration: 50% by mass) were prepared according to the same method as that for preparing the titanium oxide particle dispersion (A1) in all aspects other than that the type of the titanium oxide particles used was changed to those shown below in Table 1. Note that in the preparation of each of the titanium oxide particle dispersions (A1) to (A9), the titanium oxide particles were classified as necessary to have a corresponding D₅₀ shown below in Table 1.

TABLE 1

| Dis- | Titanium | | | | |
|---|---|---|---|---|---|
| per- | oxide | D₅₀ | | | Product |
| sion | particles | [nm] | a/b | Manufacturer | name |
| A1 | a1 | 30 | 5 | TAYCA CORPORATION | MT-500HD |
| A2 | a2 | 50 | 5 | TAYCA CORPORATION | MT-600SA |
| A3 | a3 | 150 | 5 | TAYCA CORPORATION | JR-405 |
| A4 | a4 | 200 | 5 | TAYCA CORPORATION | JR-405 |
| A5 | a5 | 100 | 5 | TAYCA CORPORATION | JR-405 |
| A6 | a6 | 100 | 2 | ISHIHARA SANGYO | CR-EL |
| | | | | KAISHA, LTD. | |
| A7 | a7 | 100 | 3 | TAYCA CORPORATION | JR-603 |
| A8 | a8 | 100 | 5 | TAYCA CORPORATION | JR-405 |
| A9 | a9 | 100 | 1 | ISHIHARA SANGYO | PT-301 |
| | | | | KAISHA, LTD. | |

### [Preparation of Titanium Oxide Particle Dispersions (B1) to (B10)]

Titanium oxide particle dispersions (B1) to (B10) (titanium oxide particle concentration: 50% by mass) were prepared according to the same method as that for preparing the titanium oxide particle dispersion (A1) in all aspects other than that the titanium oxide particles used were changed to titanium oxide particles (b1) to (b10) shown below in Table 2. Note that in the preparation of each type of the titanium oxide particle dispersions (B1) to (B10), the titanium oxide particles were classified as necessary to have a corresponding D₅₀ shown below in Table 2. The titanium oxide 10 particle dispersions (B1), (B3) to (B5), and (B8) to (B10) were second titanium oxide particle dispersions.

TABLE 2

| | Titanium | | | | |
|---|---|---|---|---|---|
| | oxide | D₅₀ | | | Product |
| Dispersion | particles | [nm] | a/b | Manufacturer | name |
| B1 | b1 | 250 | 7 | TAYCA CORPORATION | JR-301 |
| B2 | b2 | 160 | 7 | TAYCA CORPORATION | JR-605 |
| B3 | b3 | 170 | 7 | TAYCA CORPORATION | JR-605 |
| B4 | b4 | 250 | 7 | TAYCA CORPORATION | JR-301 |
| B5 | b5 | 330 | 7 | TAYCA CORPORATION | JR-301 |
| B6 | b6 | 350 | 7 | TAYCA CORPORATION | JR-301 |
| B7 | b7 | 250 | 1 | ISHIHARA SANGYO | PT-301 |
| | | | | KAISHA, LTD. | |
| B8 | b8 | 250 | 3 | TAYCA CORPORATION | JR-603 |
| B9 | b9 | 250 | 12 | TAYCA CORPORATION | JR-403 |
| B10 | b10 | 300 | 12 | TAYCA CORPORATION | JR-403 |

### [Binder Resin Particle Dispersion]

As a binder resin particle dispersion, “UPUD-ST-053D” produced by UBE corporation was used. “UPUD-ST-053D” produced by UBE Corporation was a dispersion (urethane resin particle concentration: 30% by mass) containing urethane resin particles and water.

### <Ink Preparation>

Inks (I-1) to (I-20) of Examples 1 to 11 and Comparative Examples 1 to 9 were prepared by the following methods.

### [Ink (I-1)]

First, 30.0 parts by mass of propylene glycol, 10.0 parts by mass of triethylene glycol monobutyl ether, 1.0 part by mass of a surfactant (“SURFYNOL (registered Japanese trademark) 104”, product of Nissin Chemical Industry Co., Ltd., acetylene glycol surfactant), 0.5 parts by mass of a 1% by mass sodium hydroxide aqueous solution, 6.0 parts by mass of the titanium oxide particle dispersion (A1) (containing 3.0 parts by mass of the titanium oxide particles (a1)), 24.0 parts by mass of the titanium oxide particle dispersion (B1) (containing 12.0 parts by mass of the titanium oxide particles (b1)), 11.7 parts by mass of the aforementioned binder resin particle dispersion (containing 3.5 parts by mass of binder resin particles), and water were weighted into a beaker. The amount of the water used was an amount (e.g., 16.8 parts by mass in an ink (I-1)) that gave the mass of the beaker contents 100.0 parts by mass in total. The beaker contents were stirred at a rotational speed of 400 rpm using a stirrer (“THREE-ONE MOTOR BL-600”, product of Shinto Scientific Co., Ltd.) to uniformly mix the beaker contents, thereby obtaining a mixed liquid. The mixed liquid was filtered using a filter (pore size 5 μm) to remove foreign matter and coarse particles contained in the mixed liquid. Thus, the ink (I-1) was obtained.

### [Inks (I-2) to (I-20)]

Inks (I-2) to (I-20) were prepared according to the same method as that for preparing the ink (I-1) in all aspects other than that the type and amount of the titanium oxide particle dispersion used were changed to those shown below in Table 3. Table 3 below also shows the types and percentage contents of the titanium oxide particles contained in the respective inks.

TABLE 3

| | Titanium oxide particle dispersion | | | | Titanium oxide particles | | | |
|---|---|---|---|---|---|---|---|---|
| | | Part | | Part | | % by | | % by |
| Ink | Type | by mass | Type | by mass | Type | mass | Type | mass |
| I-1 | A1 | 6.0 | B1 | 24.0 | a1 | 3.0 | b1 | 12.0 |
| I-2 | A2 | 6.0 | B1 | 24.0 | a2 | 3.0 | b1 | 12.0 |
| I-3 | A3 | 6.0 | B1 | 24.0 | a3 | 3.0 | b1 | 12.0 |
| I-4 | A4 | 6.0 | B1 | 24.0 | a4 | 3.0 | b1 | 12.0 |
| I-5 | A5 | 3.0 | B1 | 27.0 | a5 | 1.5 | b1 | 13.5 |
| I-6 | A5 | 4.5 | B1 | 25.5 | a5 | 2.25 | b1 | 12.75 |
| I-7 | A5 | 9.0 | B1 | 21.0 | a5 | 4.5 | b1 | 10.5 |
| I-8 | A5 | 10.5 | B1 | 19.5 | a5 | 5.25 | b1 | 9.75 |
| I-9 | A6 | 6.0 | B1 | 24.0 | a6 | 3.0 | b1 | 12.0 |
| I-10 | A7 | 6.0 | B1 | 24.0 | a7 | 3.0 | b1 | 12.0 |
| I-11 | A8 | 6.0 | B2 | 24.0 | a8 | 3.0 | b2 | 12.0 |
| I-12 | A8 | 6.0 | B3 | 24.0 | a8 | 3.0 | b3 | 12.0 |
| I-13 | A8 | 6.0 | B4 | 24.0 | a8 | 3.0 | b4 | 12.0 |
| I-14 | A8 | 6.0 | B5 | 24.0 | a8 | 3.0 | b5 | 12.0 |
| I-15 | A8 | 6.0 | B6 | 24.0 | a8 | 3.0 | b6 | 12.0 |
| I-16 | A8 | 6.0 | B7 | 24.0 | a8 | 3.0 | b7 | 12.0 |
| I-17 | A8 | 6.0 | B8 | 24.0 | a8 | 3.0 | b8 | 12.0 |
| I-18 | A8 | 6.0 | B9 | 24.0 | a8 | 3.0 | b9 | 12.0 |
| I-19 | — | — | B10 | 30.0 | — | — | b10 | 15.0 |
| I-20 | A9 | 6.0 | B1 | 24.0 | a9 | 3.0 | b1 | 12.0 |

Particle size distribution measurement for the titanium oxide particles were carried out on the inks (I-1) to (I-20). In the particle size distribution measurement, the ranges where the peaks were present were determined for the titanium oxide particles contained in each ink. Furthermore, a ratio of the small-diameter titanium oxide particles to the total amount of the titanium oxide particles and a ratio of the large-diameter titanium oxide particles to the total amount of the titanium oxide particles were determined based on the results (areas) of the particle size distribution measurement. In addition, a major axis length/minor axis length ratio was determined for each type of the titanium oxide particles contained in the corresponding ink by the aforementioned method. The determined results are as shown below in Table 4. The inks (I-1) to (I-20) were classified into Examples or Comparative Examples based on the determined results.

TABLE 4

| | | Small-diameter titanium | | | Large-diameter titanium | | |
|---|---|---|---|---|---|---|---|
| | | oxide particles | | | oxide particles | | |
| | | First | Rate | | Second | Rate | |
| | | peak | [% by | | peak | [% by | |
| | Ink | [nm] | mass] | a/b | [nm] | mass] | a/b |
| Compar- | I-1 | 30 | 20 | 5 | 250 | 80 | 7 |
| ative | | | | | | | |
| Example 1 | | | | | | | |
| Example 1 | I-2 | 50 | 20 | 5 | 250 | 80 | 7 |
| Example 2 | I-3 | 150 | 20 | 5 | 250 | 80 | 7 |
| Compar- | I-4 | 200 | 20 | 5 | 250 | 80 | 7 |
| ative | | | | | | | |
| Example 2 | | | | | | | |
| Compar- | I-5 | 100 | 10 | 5 | 250 | 90 | 7 |
| ative | | | | | | | |
| Example 3 | | | | | | | |
| Example 3 | I-6 | 100 | 15 | 5 | 250 | 85 | 7 |
| Example 4 | I-7 | 100 | 30 | 5 | 250 | 70 | 7 |
| Compar- | I-8 | 100 | 35 | 5 | 250 | 65 | 7 |
| ative | | | | | | | |
| Example 4 | | | | | | | |
| Example 5 | I-9 | 100 | 20 | 2 | 250 | 80 | 7 |
| Example 6 | I-10 | 100 | 20 | 3 | 250 | 80 | 7 |
| Compar- | I-11 | 100 | 20 | 5 | 160 | 80 | 7 |
| ative | | | | | | | |
| Example 5 | | | | | | | |
| Example 7 | I-12 | 100 | 20 | 5 | 170 | 80 | 7 |
| Example 8 | I-13 | 100 | 20 | 5 | 250 | 80 | 7 |
| Example 9 | I-14 | 100 | 20 | 5 | 330 | 80 | 7 |
| Compar- | I-15 | 100 | 20 | 5 | 350 | 80 | 7 |
| ative | | | | | | | |
| Example 6 | | | | | | | |
| Compar- | I-16 | 100 | 20 | 5 | 250 | 80 | 1 |
| ative | | | | | | | |
| Example 7 | | | | | | | |
| Example 10 | I-17 | 100 | 20 | 5 | 250 | 80 | 3 |
| Example 11 | I-18 | 100 | 20 | 5 | 250 | 80 | 12 |
| Compar- | I-19 | — | — | — | 300 | 100 | 12 |
| ative | | | | | | | |
| Example 8 | | | | | | | |
| Compar- | I-20 | 100 | 20 | 1 | 250 | 80 | 7 |
| ative | | | | | | | |
| Example 9 | | | | | | | |

### <Evaluation>

With respect to each of the inks of Examples 1 to 11 and Comparative Examples 1 to 9, preservation stability and whiteness, opacity, glossiness, and surface smoothness of images formed with the ink were evaluated by the following methods. Evaluation was carried out at a temperature of 25° C. and a relative humidity of 50% unless otherwise stated. The evaluation results are shown below in Tables 5 and 6.

### [Evaluation Apparatus]

As an evaluation apparatus, an inkjet recording apparatus (prototype produced by KYOCERA Document Solutions Japan Inc.) with a line head as a recording head mounted therein was used. An evaluation target (any of the inks of Examples 1 to 11 and Comparative Examples 1 to 9) was loaded into the recording head of the evaluation apparatus. As a recording medium, sheets of PET film (“LUMIRROR (registered Japanese trademark) S10#50”, product of Toray Industries, Inc., polyester film) were used.

### [Whiteness and Opacity]

Using the evaluation apparatus, a white solid image with a size of 150 mm×200 mm was formed on each of five sheets of the recording medium. Next, the formed white solid images were dried sufficiently. Next, the lightness index (L* value), chromaticness index (a* value), and image density (K value) of each of the white solid image in the CIE color space were measured using a reflectance densitometer (“RD-19”, product of X-Rite Inc). The measurement was carried out in a state in which each sheet of the recording medium was placed on a sheet of opacity test paper (black paper). The respective measurement values obtained as above were taken as a pre-correction L* value, pre-correction a* value, and pre-correction K value.

Next, an unused sheet of the recording medium (a sheet of the recording medium with the white solid image not formed thereon) was placed on a sheet of the opacity test paper and a laminate was prepared. Using the aforementioned reflectance densitometer, the lightness index (L* value), chromaticness index (a* value), and image density (K value) of the laminate in the CIE color space were measured. The respective measurement values obtained as above were taken as a base L* value, base a* value, and base K value.

Next, a corrected L* value and a corrected a* value were obtained by applying the pre-correction L* value, the pre-correction a* value, the base L* value, and the base a* value to the following formulas. The corrected L* value and the corrected a* value are true measurement values obtained by removing influence of the recording medium and the opacity test paper from the pre-correction L* value and the pre-correction a* value, respectively. Furthermore, an opacity was calculated by applying the pre-correction K value and the base K value to the following formula.

$$Corrected L * value = pre - correction L * value - base L * value$$

$$Corrected a * value = pre - condition a * value - base a * value$$

$$Opacity = 100 \times ( 1 - pre - correction K value / base K value$$

The measurement was carried out on each of the 5 white solid images formed on the 5 sheets of the recording medium. The averages of the five corrected L* values, five corrected a* values, and five opacity values were taken as an average L* value, average a* value, and average opacity, respectively. A lightness (average L* value) of at least 80 was taken as a pass (OK), and a lightness of less than 80 was taken as a failure (NG). A redness (average a* value) of greater than −3.0 and less than 1.0 was taken as a pass (OK), and a redness of no greater than −3.0 or at least 1.0 was taken as a failure (NG). Whiteness and opacity were evaluated according to the following criteria.

### (Criteria of Whiteness)

A (good): passed in both lightness (average L* value) and redness (average a* value)
B (poor): failed in at least one of lightness (average L* value) and redness (average a* value)

### (Criteria of Opacity)

A (particularly good): average opacity of greater than 90%
B (good): average opacity of greater than 85% and no greater than 90%
C (poor): average opacity of no greater than 85%

### [Glossiness]

Using the evaluation apparatus, a white solid image with a size of 150 mm×200 mm was formed on each of five sheets of the recording medium. Next, the formed white solid images were dried sufficiently. Next, the glossiness of each of the white solid image was measured using a gloss meter (product of Elcometer). The measurement was carried out at 3 randomly selected locations on the white solid image at a measurement angle of 60 degrees. The average of the measured three measurement values was taken as a glossiness of the white solid image being a target.

The measurement was carried out on each of the five white solid images formed on the five sheets of the recording medium. The average of the resultant five glossiness values was taken as an average glossiness. Glossiness was evaluated according to the following criteria.

### (Criteria of Glossiness)

A (particularly good): average glossiness of 90 or more
B (good): average glossiness of at least 70 and less than 90
C (poor): average opacity of less than 70

### [Surface Smoothness]

In evaluation of surface smoothness, a cyan ink was prepared first. In detail, a cyan pigment dispersion (cyan pigment concentration: 50% by mass) was prepared according to the same method as that for preparing the titanium oxide particle dispersion (A1) in all aspects other than that the same amount of a cyan pigment (“HELIOGENDBLUE 7088”, product of BASF, C.I. Pigment Blue 15:3) was used instead of the titanium oxide particles (a1).

Next, 30.0 parts by mass of propylene glycol, 10.0 parts by mass of triethylene glycol monobutyl ether, 1.0 part by mass of a surfactant (“SURFYNOL (registered Japanese trademark) 104”, product of Nissin Chemical Industry Co., Ltd., acetylene glycol surfactant), 0.5 parts by mass of a 1% by mass sodium hydroxide aqueous solution, 8 parts by mass of the cyan pigment dispersion (containing 4 parts by mass of the cyan pigment), 11.7 parts by mass of the aforementioned binder resin particle dispersion (containing 3.56 parts by mass of binder resin particles), and water were weighted into a beaker. The amount of the water used was an amount that gave the mass of the beaker contents 100.0 parts by mass in total. The beaker contents were stirred at a rotational speed of 400 rpm using a stirrer (“THREE-ONE MOTOR BL-600”, product of Shinto Scientific Co., Ltd.) to uniformly mix the beaker contents, thereby obtaining a mixed liquid. The mixed liquid was filtered using a filter (pore size 5 μm) to remove foreign matter and coarse particles contained in the mixed liquid. Through the above, the cyan ink was obtained.

Using the evaluation apparatus, a white solid image with a size of 150 mm×200 mm was formed on each of five sheets of the recording medium. Next, the formed white solid images were dried sufficiently. Next, the cyan ink was loaded into the line head as a recording head of the evaluation apparatus. Next, a thin line was formed with the cyan ink on each of the white solid images on the five sheets of the recording medium using the evaluation apparatus. The formed thin line was visually observed to check the presence or absence of distortion. When a white solid image has low surface smoothness, distortion occurs in a formed thin line. Surface smoothness of the white solid image was evaluated according to the following criteria.

### (Criteria of Surface Smoothness)

A (good): No distortion occurred in thin line.
B (poor): Distortion occurred in thin line.

### [Preservation Stability]

An evaluation target (any of the inks of Examples 1 to 11 and Comparative Examples 1 to 9) was loaded into a container with a lid and left to stand for 1 month. After the leaving to stand, tilting stirring was carried out 50 times against the container with the lid. After 20 tilting stirrings and 50 tilting stirrings, the container contents were visually observed to check the presence or absence of precipitate. The titanium oxide particles and the like will precipitate in an evaluation target with low preservation stability if left to stand, and will not readily redisperse even with stirring. Therefore, the presence or absence of the precipitate indicates a level of preservation stability of the evaluation target. Preservation stability was evaluated according to the following criteria.

### (Criteria of Preservation Stability)

A (particularly good): No precipitate was present after 20 tilting stirrings.
B (good): Precipitate was present after 20 tilting stirrings but not after 50 tilting stirrings.
C (poor): Precipitate was present after 50 tilting stirrings.

TABLE 5

| | | Whiteness | | | | | Opacity | |
|---|---|---|---|---|---|---|---|---|
| | | Lightness | | Redness | | | Average | |
| | | | Passed/ | | Passed/ | | opacity | |
| | Ink | L* | failed | a* | failed | Rating | [%] | Rating |
| Comparative | I-1 | 78 | NG | −0.8 | OK | B | 82 | C |
| Example 1 | | | | | | | | |
| Example 1 | I-2 | 80 | OK | −0.5 | OK | A | 86 | B |
| Example 2 | I-3 | 85 | OK | 0.8 | OK | A | 90 | A |
| Comparative | I-4 | 90 | OK | 1.5 | NG | B | 94 | A |
| Example 2 | | | | | | | | |
| Comparative | I-5 | 87 | OK | 1.2 | NG | B | 92 | A |
| Example 3 | | | | | | | | |
| Example 3 | I-6 | 85 | OK | 0.8 | OK | A | 88 | B |
| Example 4 | I-7 | 80 | OK | 0.2 | OK | A | 86 | B |
| Comparative | I-8 | 75 | NG | −0.2 | OK | B | 84 | C |
| Example 4 | | | | | | | | |
| Example 5 | I-9 | 84 | OK | 0.5 | OK | A | 87 | B |
| Example 6 | I-10 | 84 | OK | 0.5 | OK | A | 88 | B |
| Comparative | I-11 | 74 | NG | −1.5 | OK | B | 84 | C |
| Example 5 | | | | | | | | |
| Example 7 | I-12 | 80 | OK | −1.2 | OK | A | 86 | B |
| Example 8 | I-13 | 84 | OK | 0.5 | OK | A | 90 | B |
| Example 9 | I-14 | 82 | OK | 1.0 | OK | A | 88 | B |
| Comparative | I-15 | 81 | OK | 1.3 | NG | A | 86 | B |
| Example 6 | | | | | | | | |
| Comparative | I-16 | 84 | OK | 0.5 | OK | B | 88 | B |
| Example 7 | | | | | | | | |
| Example 10 | I-17 | 84 | OK | 0.5 | OK | A | 88 | B |
| Example 11 | I-18 | 84 | OK | 0.5 | OK | A | 88 | B |
| Comparative | I-19 | 91 | OK | 2.4 | NG | B | 97 | A |
| Example 8 | | | | | | | | |
| Comparative | I-20 | 85 | OK | 0.5 | OK | A | 88 | B |
| Example 9 | | | | | | | | |

TABLE 6

| | | Glossiness | | | |
|---|---|---|---|---|---|
| | | Mea- | | Surface | Preser- |
| | | surement | | smooth- | vation |
| | Ink | value | Rating | ness | stability |
| Comparative Example 1 | I-1 | 102 | A | A | A |
| Example 1 | I-2 | 101 | A | A | A |
| Example 2 | I-3 | 100 | A | A | A |
| Comparative Example 2 | I-4 | 100 | A | A | A |
| Comparative Example 3 | I-5 | 105 | A | A | A |
| Example 3 | I-6 | 103 | A | A | A |
| Example 4 | I-7 | 98 | A | A | A |
| Comparative Example 4 | I-8 | 95 | A | A | A |
| Example 5 | I-9 | 86 | B | A | A |
| Example 6 | I-10 | 103 | A | A | B |
| Comparative Example 5 | I-11 | 115 | A | A | A |
| Example 7 | I-12 | 112 | A | A | A |
| Example 8 | I-13 | 100 | A | A | A |
| Example 9 | I-14 | 95 | A | A | A |
| Comparative Example 6 | I-15 | 93 | A | A | C |
| Comparative Example 7 | I-16 | 56 | C | B | A |
| Example 10 | I-17 | 78 | B | A | A |
| Example 11 | I-18 | 120 | A | A | A |
| Comparative Example 8 | I-19 | 125 | A | A | A |
| Comparative Example 9 | I-20 | 69 | C | A | A |

As shown in Tables 1 to 6, each of the inks of Examples 1 to 11 contained titanium oxide particles and an aqueous medium. In the particle size distribution measurement, the titanium oxide particles exhibited at least the first peak present in a particle diameter range of at least 40 nm and no greater than 155 nm and the second peak present in a particle diameter range of at least 165 nm and no greater than 340 nm. Where of the titanium oxide particles, titanium oxide particles with a particle diameter of at least 40 nm and no greater than 155 nm were taken as first titanium oxide particles and titanium oxide particles with a particle diameter of at least 165 nm and no greater than 340 nm were taken as second titanium oxide particles, the ratios of the major axis length to the minor axis length of the first titanium oxide particles and the second titanium oxide particles each were at least 2 and no greater than 15. The first titanium oxide particles had a percentage content of at least 12.0% by mass and no greater than 33.0% by mass in the titanium oxide particles. The second titanium oxide particles had a percentage content of at least 67.0% by mass and no greater than 88.0% by mass in the titanium oxide particles. The inks of Examples 1 to 11 had excellent preservation stability and formed images with high whiteness, opacity, glossiness, and surface smoothness.

By contrast, in the particle size distribution measurement for the titanium oxide particles of the ink (I-1) of Comparative Example 1, the first peak was present in a particle diameter range of less than 40 nm. The ink (I-1) formed images with insufficient lightness and opacity due to the particle diameter of the small-diameter titanium oxide particles being too small.

In the particle size distribution measurement for the titanium oxide particles of the ink (I-4) of Comparative Example 2, the first peak was present in a particle diameter range of greater than 155 nm. The ink (I-4) formed reddish images due to the particle diameter of the small-diameter titanium oxide particles being too large.

The ink (I-5) of Comparative Example 3 contained the first titanium oxide particles at a percentage content of less than 12.0% by mass and the second titanium oxide particles at a percentage content of greater than 88.0% by mass. The ink (I-5) formed reddish images due to an insufficient amount of the first titanium oxide particles and an excessive amount of the second titanium oxide particles.

The ink (I-8) of Comparative Example 4 contained the first titanium oxide particles at a percentage content of greater than 33.0% by mass and the second titanium oxide particles at a percentage content of less than 67.0% by mass. The ink (I-8) formed images with insufficient lightness and opacity due to an excessive amount of the first titanium oxide particles and an insufficient amount of the second titanium oxide particles.

In the particle size distribution measurement for the titanium oxide particles of the ink (I-11) of Comparative Example 5, the second peak was present in a particle diameter range of less than 165 nm. The ink (I-11) formed images with insufficient lightness and opacity due to the particle diameter of the second titanium oxide particles being too small.

In the particle size distribution measurement for the titanium oxide particles of the ink (I-15) of Comparative Example 6, the second peak was present in a particle diameter range of less than 340 nm. Due to the particle diameter of the large-diameter titanium oxide particles being too large, the ink (I-15) formed reddish images and was rated as poor in preservation stability.

The ink (I-16) of Comparative Example 7 had a ratio of the major axis length to the minor axis length of the second titanium oxide particles of less than 2. The ink (I-16) was rated as poor in glossiness and surface smoothness of formed images due to the second titanium oxide particles being nearly spherical.

The ink (I-19) of Comparative Example 8 formed reddish images due to not containing the first titanium oxide particles.

The ink (I-20) of Comparative Example 9 had a ratio of the major axis length to the minor axis length of the first titanium oxide particles of less than 2. The ink (I-20) was rated as poor in glossiness of formed images due to the first titanium oxide particles being nearly spherical.

What is claimed is:

1. A white ink for inkjet printing, comprising:
titanium oxide particles; and
an aqueous medium, wherein
the titanium oxide particles exhibit at least a first peak and a second peak in particle size distribution measurement, the first peak being present in a particle diameter range of at least 40 nm and no greater than 155 nm, the second peak being present in the particle diameter range of at least 165 nm and no greater than 340 nm, and
where of the titanium oxide particles, titanium oxide particles with a particle diameter of at least 40 nm and no greater than 155 nm are taken as first titanium oxide particles and titanium oxide with a particle diameter of at least 165 nm and no greater than 340 nm are taken as second titanium oxide particles,
ratios of major axis length to minor axis length of the first titanium oxide particles and the second titanium oxide particles each are at least 2 and no greater than 15,
the first titanium oxide particles have a percentage content of at least 12.0% by mass and no greater than 33.0% by mass in the titanium oxide particles, and
the second titanium oxide particles have a percentage content of at least 67.0% by mass and no greater than 88.0% by mass in the titanium oxide particles.

2. The white ink for inkjet printing according to claim 1, further comprising
a pigment dispersion resin.

3. The white ink for inkjet printing according to claim 1, wherein
the ratio of the major axis length to the minor axis length of the first titanium oxide particles is at least 3 and no greater than 15.

4. The white ink for inkjet printing according to claim 1, wherein
the ratio of the major axis length to the minor axis length of the second titanium oxide particles is at least 5 and no greater than 15.

5. The white ink for inkjet printing according to claim 1, further comprising
binder resin particles.

6. The white ink for inkjet printing according to claim 1, wherein
the white ink for inkjet printing is used for front printing.
